(19) United States
(12) Patent Application Publication
(10) Pub. No.: US 2005/0174407 A1
(43) Pub. Date: Aug. 11, 2005

(54) Depositing solid materials

(76) Inventors: Daniel R Johnson, Melvern, Worcestershire (GB); William N. Damerell, Famborough Hampshire (GB); Anthony W.N. Kynaston-Pearson, Bampton, Oxfordshire (GB)

Correspondence Address: NIXON & VANDERHYE, PC, 901 NORTH GLEBE ROAD, 11TH FLOOR, ARLINGTON, VA, 22203, US

(21) Appl. No.: 10/497,660

(22) PCT Filed: Dec. 3, 2002
(86) PCT No.: PCT/GB02/05446

(51) Int. Cl. B41J 2/17

(52) U.S. Cl. 347/95

(57) ABSTRACT

Material can be deposited directly onto a substrate by using a fluid applicator such as an inkjet printer to apply at least two fluids which react to give the desired material for a range of applications. Thus, multiples of a printing mechanism are used to deposit materials as reagents that react together to form products. The materials may also be advantageously deposited from multiple inkjet heads to prepare a wide range of reaction scenarios in the form of user-defined patterns which may be sequences of differing layers and possibly to build up thicker layers. Thus, a PCB could be printed by the inkjet printer by simply printing the metal salt and the reducing agent directly, instead of two colours from a conventional inkjet printer for example. To print a three dimensional article, a pair of fluids which react to give a precipate can be used instead. Repeated passes can then build up a desired shape. The two processes could be combined to produce composite devices such as electrical components.

### FIELD OF THE INVENTION

The present invention relates to the deposition of solid materials. It provides a method of doing so, and a printer for doing so.

### BACKGROUND ART

The production of printed circuit boards (PCBs) is a major market that has expanded with the rise in electronic, computing and other such industries. As the process of electronic integration has developed, there has been a corresponding demand for finer and more accurate detail in the PCB production process, with narrower conductive tracks and greater densities of components. Finer tracks ease the use of surface mount technologies such as ‘flip chip’ or the like. Electroless deposition is used to coat whole surfaces, and the formation of metal patterns requires additional and costly processing such as photolithography and etching. Existing PCB technology uses lithographic techniques to obtain a resolution of 50 μm, but this is an optimal outcome that is not typically available over the whole of a large PCB. The process is also limited by inherent flaws such as errors arising from faulty or damaged lithographs, scatter of light, and possible undercutting of metal tracks during etching.

In other fields, three dimensional printers have been developed to allow rapid prototyping of new designs. These work according to two general principles. In one case a block of a friable material is etched or abraded to leave behind the desired shape, and in another a settable liquid such as a epoxy is scanned with a laser or the like to define a shape. The liquid is drained to leave behind the areas which have been set by chemical reactions triggered by the laser. Such printers are expensive and slow and have not therefore found general application outside specialist areas where their cost is justified.

The present invention seeks to provide a ‘solid’ printer, i.e. one able to deposit an essentially solid material and/or a material which can subsequently interact and/or change its properties, for example to produce another material that may solidify or change its physical state or properties. This could be used as a replacement for existing three dimensional printers, or to print single or multiple two dimensional patterns such as a PCB layout.

Our previous application no: GB0113408.9 filed on 4 Jun. 2001 proposed the use of an inkjet printer to apply a promoter type material such as SnCl₂ or catalytic palladium to a substrate prior to exposing the substrate to an electroless deposition process. Such processes employ a solution of a metal salt and a reducing agent in combination with stabilisers to prevent plating out of the metal until exposure to the promoter. This allows PCBs to be made to the resolution of an inkjet printer, which is now down to the order of 20 μm.

However, this approach still requires the use of an electroless deposition solution. The stabilisers employed can be aggressive in nature and it may be desirable to avoid these. However, a stabiliser is normally needed since these solutions are unstable without them and so can spontaneously plate out at random.

### SUMMARY OF THE INVENTION

An objective of the present invention is to deposit material directly onto the substrate by using a fluid applicator such as an inkjet printer to apply at least two fluids which react to give the desired material for a range of applications.

Thus, multiples of a printing mechanism are used to deposit materials as reagents that react together to form products. Normally, desirable products are in the form of solids and the reagents that produce them are solvated by liquids. In the case of inkjet printing however, many solids present difficulties in being printed and preclude the use of this technology for potential applications. The advantage of the approach in the present invention is that reagents may be prepared in a solvated form and formulated into printable “inks” which are able to pass readily through any print transfer mechanism, although they may or may not be coloured. The “inks” are formulated so that, either during the process of print-transfer to the substrate or on the printed surface itself, they react together to form a product that will remain in situ and/or will gel or solidify and form a coating on the substrate surface. The materials may also be advantageously deposited from multiple inkjet heads to prepare a wide range of reaction scenarios in the form of user-defined patterns which may be sequences of differing layers and possibly to build up thicker layers.

Thus, a PCB could be printed by the inkjet printer by simply printing the metal salt and the reducing agent directly, instead of two colours from a conventional inkjet printer for example. Inkjet printers currently provide a plurality of fluid channels to allow colour printing (for example) and can thus cope with the necessary combinations of fluids.

To print a three dimensional article or a two dimensional insulator, a pair of fluids which react to give a precipitate can be used instead. Repeated passes can then build up a desired shape.

Thus, the use of fluids that react to give a product with substantially different conductive properties offers significant advantages in the manufacture of such devices.

The two processes could be combined to produce electrical components. For example, a conductive area could be formed, covered with a thin non-conductive layer, and further covered with a conductive layer to form a capacitor as part of the PCB itself. Various metals and compounds for example oxides or chalcogenides can be printed as coatings that are functional and multifunctional for applications that include optical layers, electro-optical devices, semiconductor devices and multifunctional multilayer composite structures. A significant advantage of the present invention comes from the ability to meter exact quantities through the printing process, thereby achieving a high level of control over the type of materials fabricated and the yield and cost of production processes. For example, exact quantities of expensive materials may be deposited, layers of materials may be prepared and built to precise thickness, density, of known stoichiometry or concentration of dopants.

In an alternative aspect of the invention, the fluids react to yield a chemically active species. This can, for instance, react with a subsequent reagent to form the desired deposit, or it can catalyse a subsequent reaction.

### BRIEF DESCRIPTION OF THE DRAWINGS

Embodiments of the invention will now be described, by way of example, with reference to the accompanying figures, in which;

FIG. 1 is a schematic illustration of a printing apparatus according to the present invention;

FIG. 2 is a schematic illustration of an alternative printing apparatus according to the present invention; and

FIGS. 3A and 3B are schematic illustrations showing the operation of a printing apparatus according to the present invention.

### DETAILED DESCRIPTION OF THE EMBODIMENTS

In a first embodiment, the inkjet printer prints a PCB conductor by simply printing the metal salt and the reducing agent directly, instead of red and green ink (for example). The advantage is therefore in removing the need for the usual electroless bath process and its associated stabilisers. The PCB can be printed to the resolution of the inkjet printer, typically 20 μm at present as noted above.

In a second embodiment, reactive inks containing solvated species are combined to produce ceramic materials which may be in their final or alternatively “green” states. The “green” state refers to an intermediate ceramic material that has then to be sintered into its final form. Examples include hydroxides, carbonates or oxides of metals. The advantage of this approach is that reactions at the substrate result in improved material conformity with the substrate and the formation of a more dense material after this and subsequent processes, as compared to for example the printing of inks having the same solids contained in an organic binder. The ceramic layer can thus be built into two or three-dimensional structures. The resulting ceramic may have a wide range of properties, for example it may be an insulator such as calcium carbonate or a transparent conductor, such as zinc oxide. To print a three-dimensional article, a pair of fluids can be used which react to give a precipitate and thereafter built up into a desired shape with for example repeat printing passes.

In a third embodiment, sequential inkjet printing of a variety of materials is proposed, to build up multiple layers with differing properties. For example, inks could react together to form solid deposits of dielectrics such as ceramics or conductors hereinbefore described, or alternatively adhesive-like layers such as epoxy resins from two part inks. These types of materials may then be deposited sequentially in a user-defined way from an array of inkjet heads. The layers may also be combined with those formed more simply using dried inks from single inkjet heads. Thus, two processes could be combined for example to produce electrical components. In this way a conductive area could be formed, followed by a thin dielectric layer and further covered with conductor to form a capacitor as part of a PCB layout.

A further advantage of the present invention is that the process line may employ a larger series of inkjet heads beneath which substrates undergo a single pass at greater speed of throughput, to fabricate multiples of thin films or to build up thicker deposits.

In a fourth embodiment of the present invention, materials may be deposited from multiples of inkjet heads that react together to form catalytic layers which can be employed in a wide range of synthetic or decomposition chemistries. Examples include homogenous and heterogenous catalysts, used in gas, liquid or solid environments, include metals such as platinum, rhodium and palladium and metal oxides containing catalytic sites, e.g. perovskite cage structures. These catalysts are used in synthetic or decomposition reactions in organic or inorganic chemistry, for example in the Fischer-Tropsch synthesis of organic molecules, petrochemical cracking, or in the decomposition of hydrocarbons in catalytic converters. Homogeneous catalytic materials include enzymes which are used, for example in biochemical testing in diagnostic arrays and for de-compositional analysis of biopoloymers and systems that mimic proteozone behaviour. Homogeneous catalysts also include negative catalysts, commonly known as inhibitors, which moderate reactions. For example ink formulations may be prepared for multihead inkjet printing of materials used to prepare surfaces for electroless coating of metals. In particular it is possible to co-print a solution of a reducing agent or ‘sensitiser’, for example SnCl₂ and a second solution of a compound such as PdCl₂ which results in reaction on the printed pattern to form an ‘activator’ of catalytic palladium metal. This may then be used to promote electroless plating of metals such as cobalt, nickel and copper in the manufacture of PCBs etc. The advantage of this approach is that the pre-treatment baths of SnCl₂ and PdCl₂ are eliminated from the electroless coating process line and use of expensive palladium compounds are kept to a minimum by exact metering of material only onto areas required for electroless metal deposition.

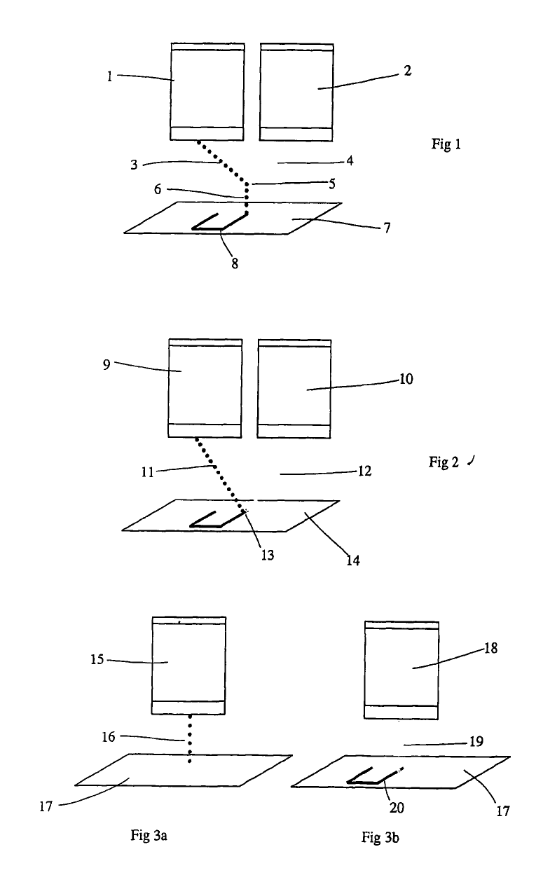

Referring to FIG. 1, a pair of inkjet printing devices 1, 2 eject ink droplets 3, 4 respectively in a direction such that they coincide during flight at 5 forming mixed droplets 6 which continue onwards towards a substrate 7. The substrate 7 and/or the inkjet printing heads 1, 2 are indexed and the stream of droplets 3, 4 started and stopped so as to define a printed pattern 8 on the substrate 7. This printed pattern 8 is made up of the combined droplets 6.

Referring to FIG. 2, a pair of inkjet devices 9, 10 again eject droplets 11, 12, this time aimed such that their point of coincidence 13 is at the substrate 14.

The two possibilities thus give different options as to the mixing conditions of the two streams of droplets. In the embodiment of FIG. 1, the droplets enjoy a short period of time during which they mix as fluids in open air, whereas this period is eliminated in the embodiment of FIG. 2 in which the droplets mix on the solid surface of the substrate 14. The choice as between these two arrangements will depend on the specific chemistry of the reagents involved.

FIGS. 3A and 3B show an inkjet printing device 15 which ejects droplets 16 towards a substrate 17. The substrate 17 then moves to a further position or the inkjet printing device 15 is replaced with a further device 18, and different droplets 19 are ejected to form a like pattern 20 on the substrate 17. This provides a further alternative set of mixing conditions.

A wide variety of fluid can be used in the above-described apparatus and process. One option is to use fluids which are suitable for electroless deposition and will thus react as necessary. The stabilisers etc can be omitted as the fluids will remain mixed for only a short time. Thus, one fluid can be a metal compound such as a compound of Cobalt, Nickel, Gold, Silver, Palladium or Copper. The other can be a reducing agent such as one or more of a hydrophosphite, a hydrazine, a borane or amine borane, glucose, borohydride, aldehydes, tartrates and tin(II) compounds, to reduce the metal compound to the free metal.

Another alternative is to select fluids which react to yield a ceramic precipitate, either in a green (unsintered form) or a final form. Alkali metal compounds such as sodium carbonate and sodium hydroxide or compounds such as ammonium carbonate and ammonium hydroxide are useful in this respect, by reacting with a soluble salts of non-alkali metals such as calcium, aluminium, copper, cobalt, cerium, indium, iron, manganese, nickel, silver, tin, tungsten, vanadium, zinc. The fluids thus containing soluble compounds are able to react to give a precipitate of the relevant ceramic compound. It will thus be apparent to one skilled in the art that by combining two or more solvated materials it is possible to prepare solid-state products having a wide range of structural and chemical properties and electronic properties ranging from metallic to semiconducting and insulating.

As an example, oxides may be fabricated as conducting or insulating ceramics, or alternatively, chalcogenides can be used instead, with metal ions such as copper, indium or cadmium to produce compound semiconductors for use in discrete devices such as photodiodes, photovoltaics or transistors.

The substrate can be treated with an activating agent to promote a chemical reaction. Activating agents include catalysts and promoters for the reaction concerned. Reducing agents act as sensitisers that coat surfaces with reaction products. In addition, the sensitising agent can react with one of the fluids to form a coating of catalytic material.

It will be appreciated that many variations may be made to the above-described embodiments without departing from the scope of the present invention.

1-47. (canceled)

48. A printer comprising;
at least one print head adapted to eject quantities of at least two separate fluids towards a substrate;
at least two reservoirs of fluid connected to the print head to supply fluid thereto for ejection;
the reservoirs containing fluids which are capable of reacting chemically when in contact with each other to yield a product on said substrate

49. A printer according to claim 48 wherein the fluids are capable of reacting to produce a product having conductive properties differing from those of the fluids.

50. A printer according to claim 48 wherein the fluids are capable of reacting to produce a product which is a solid or gel.

51. A printer according to claim 48 in which the fluids are ejected in droplets.

52. A printer according to claim 48 in which the print head is an inkjet printer.

53. A printer according to claim 48 in which the print head is adapted to eject quantities of each fluid to be deposited at the same location on a substrate.

54. A printer according to claim 48 in which the print head is adapted to eject fluids such that they mix in flight.

55. A printer according to claim 48 in which the print head is adapted to eject the fluids from separate ports.

56. A printer according to claim 48 wherein in the product is capable of reacting with an electroless deposition solution.

57. A printer according to claim 56 in which one fluid is or contains a metal compound.

58. A printer according to claim 48 in which the fluids are capable of reacting to yield an electronic conductor.

59. A printer according to claim 58, wherein the electronic conductor is a metallic species.

60. A printer according to claim 87 in which the metal compound is a compound of one or more of cobalt, nickel, gold, silver, palladium and copper.

61. A printer according to claim 56 in which one fluid includes a reducing agent.

62. A printer according to claim 61 in which the reducing agent is one or more of a hydrophosphite, a hydrazine, a borane or amine borane, glucose, borohydride, aldehydes, tartrates and tin(II) compounds.

63. A printer according to claim 48 in which the fluids are selected such that the reaction yields a ceramic precipitate in one of a ‘green’ and/or a final form.

64. A printer according to claim 63 in which one fluid is alkaline by containing compounds of alkali metals or ammonium ions.

65. A printer according to claim 64 in which the fluid includes at least one of sodium carbonate, sodium hydroxide, ammonium carbonate and ammonium hydroxide.

66. A printer according to claim 63 in which one fluid is or contains a soluble salt of a non-alkali metal such as calcium, aluminium, copper, cobalt, cerium, indium, iron, manganese, nickel, silver, tin, tungsten, vanadium and zinc.

67. A printer according to claim 48 in combination with a substrate which has been treated with an activating or sensitising agent to promote the chemical reaction.

68. A printer according to claim 67 in which the activating or sensitising agent is one of a catalyst, a promoter for the reaction concerned, and a reducing agent.

69. A printer according to claim 67 in which the sensitising agent reacts with one of the fluids to form a catalytic material.

70. A printer according to claim 48 in which the product is chemically reactive.

71. A printer according to claim 48 in which the product is catalytically active.

72. A printer according to claim 48 in which the product is catalytic to the deposition of a product having conductive properties.

73. A method of forming a shaped solid layer on a substrate in which droplets of at least two fluids are ejected towards the substrate, and allowing the fluids to react chemically after ejection to yield a solid product on the substrate.

74. A method according to claim 73, wherein the product is chemically reactive.

75. A method according to claim 73, wherein the product is catalytically active.

76. A method according to claim 73 in which an inkjet printer ejects the droplets.

77. A method according to claim 73n which the fluids are suitable for electroless deposition.

78. A method according to claim 76n which one fluid is or contains a metal salt.

79. A method according to claim 78 in which the metal salt is a salt of one or more of cobalt, nickel, gold, silver and copper.

80. A method according to claim 77 in which one fluid is a reducing agent.

81. A method according to claim 80 in which the reducing agent is one or more of a hydrophosphite, a hydrazine, a borane or amine borane, glucose, borohydride, aldehydes, tartrates and a tin (II) compound.

82. A method according to claim 76 in which the fluids are selected such that the reaction yields a ceramic precipitate.

83. A method according to claim 82 in which one fluid is or contains an alkali metal salt.

84. A method according to claim 83 in which the fluid is or contains sodium carbonate.

85. A method according to claim 82 in which one fluid is or contains a soluble salt of calcium.

86. A method according to claim 76 including the step of sensitising or activating the substrate with an agent able to promote the chemical reaction.

87. A method according to claim 86 in which the activating or sensitising agent is one of a catalyst, a promoter and a reducing agent for the reaction concerned.

88. A method according to claim 76 in which the fluids form a two part adhesive.

89. A method according to claim 88 in which the adhesive is an epoxy resin.

90. A substrate with a layer of patterned material having conductive, electronic or electro-optical properties deposited by applying droplets of at least two fluids thereon, and allowing the fluids to react chemically after ejection to yield a solid product.

91. A substrate according to claim 90 in which the product is electronically conductive.

92. A substrate according to claim 91 in which the product is semiconducting.

93. A substrate according to claim 91 in which the product is a dielectric.
